(19) United States
(12) Patent Application Publication
(10) Pub. No.: US 2024/0246541 A1
(43) Pub. Date: Jul. 25, 2024

(54) SYSTEMS AND METHODS FOR ANALYZING VERTICAL FORCE ON A STEERING COLUMN FOR DETERMINING OPERATOR VIGILANCE

(71) Applicant: Woven by Toyota, Inc., Tokyo (JP)

(72) Inventors: Manuel Ludwig Kuehner, Mountain View, CA (US); Hiroshi Yasuda, San Francisco, CA (US)

(73) Assignee: Woven by Toyota, Inc., (omitted)

(21) Appl. No.: 18/157,144

(22) Filed: Jan. 20, 2023

(51) Int. Cl. B60W 40/08; B60W 40/02

(52) U.S. Cl. CPC B60W 40/08; B60W 40/02; B60W 2420/22; B60W 2540/043; B60W 2540/229

(57) ABSTRACT

System, methods, and other embodiments described herein relate to vigilance evaluator. In one embodiment, a method includes receiving a vertical force measurement based on a force sensor attached to a steering column; and estimating a level of operator vigilance based on the vertical force measurement.

### TECHNICAL FIELD

The subject matter described herein relates, in general, to operator vigilance, and, more particularly, to determining operator vigilance in accordance with analyzing vertical forces exerted on a steering column.

### BACKGROUND

Vehicles may be equipped with automated driving assistance systems. In these systems an operator may be expected to control and supervise a vehicle, even if lateral control and longitudinal control are handled by the automated driving system. Under such an arrangement, the operator may be expected to take control if the ADS unexpectedly disengages due to issues with sensor data (e.g., an obstructed camera), sudden weather changes, unexpected traffic conditions, and so on.

### SUMMARY

In one embodiment, example systems and methods relate to a manner of estimating operator vigilance.

In one embodiment, a method for estimating operator vigilance is disclosed. In one embodiment, the method includes receiving a vertical force measurement based on a force sensor attached to a steering column; and estimating a level of operator vigilance based on the vertical force measurement.

In one embodiment, a vigilance evaluator system is disclosed. The vigilance evaluator system includes one or more processors and a memory communicably coupled to the one or more processors. The memory stores a command module including instructions that when executed by the one or more processors cause the one or more processors to receive a vertical force measurement based on a force sensor attached to a steering column; and estimate a level of operator vigilance based on the vertical force measurement.

In one embodiment, a non-transitory computer-readable medium including instructions that when executed by one or more processors cause the one or more processors to perform one or more functions is disclosed. The instructions include instructions to receive a vertical force measurement based on a force sensor attached to a steering column; and estimate a level of operator vigilance based on the vertical force measurement.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a vigilance evaluator system that is associated with estimating operator vigilance.

FIG. 3 illustrates one embodiment of the vigilance evaluator system of FIG. 2 in a cloud-computing environment.

FIG. 4 illustrates one embodiment of a steering interface incorporating a vertical force sensor.

FIG. 5A illustrates one example of a steering interface using a strain-gauge sensor on a steering column to measure vertical force on the steering column.

FIG. 5B illustrates a close-up view of the strain-gauge sensor on the steering column.

FIG. 6A illustrates a first body posture example of a vehicle operator in a high vigilance state.

FIG. 6B illustrates a second body posture example of a vehicle operator in a low vigilance state.

FIG. 7 illustrates one embodiment of a method for using a vigilance evaluator system to estimate a level of operator vigilance.

### DETAILED DESCRIPTION

Systems, methods, and other embodiments associated with analyzing vertical forces on a steering column and estimating operator vigilance are disclosed herein. Various methods of autonomous driving may require that drivers remain engaged with a steering wheel for autonomous driving assistance to remain in effect. In such a context, even when drivers are holding a steering wheel, the extent to which drivers are engaged with the steering wheel can differ as their vigilance increases or decreases. For example, capacitive or grip sensors on a steering wheel may not detect that a driver is merely hanging their hands on a steering wheel. Further, capacitive or grip sensors may add considerable cost to a vehicle or may annoy drivers by requiring them to interact with a steering wheel in specific ways.

A different approach is disclosed herein, which may be used with or as alternative to capacitive sensors or grip sensors, where a force sensor may be attached to a steering column to measure vertical forces exerted on the steering column via the steering wheel. Accordingly, when a driver is lazy, tired, or otherwise less vigilant, their relaxed body posture may be detected via the force sensor through higher vertical loads placed on the steering column and a lower state of operator vigilance established.

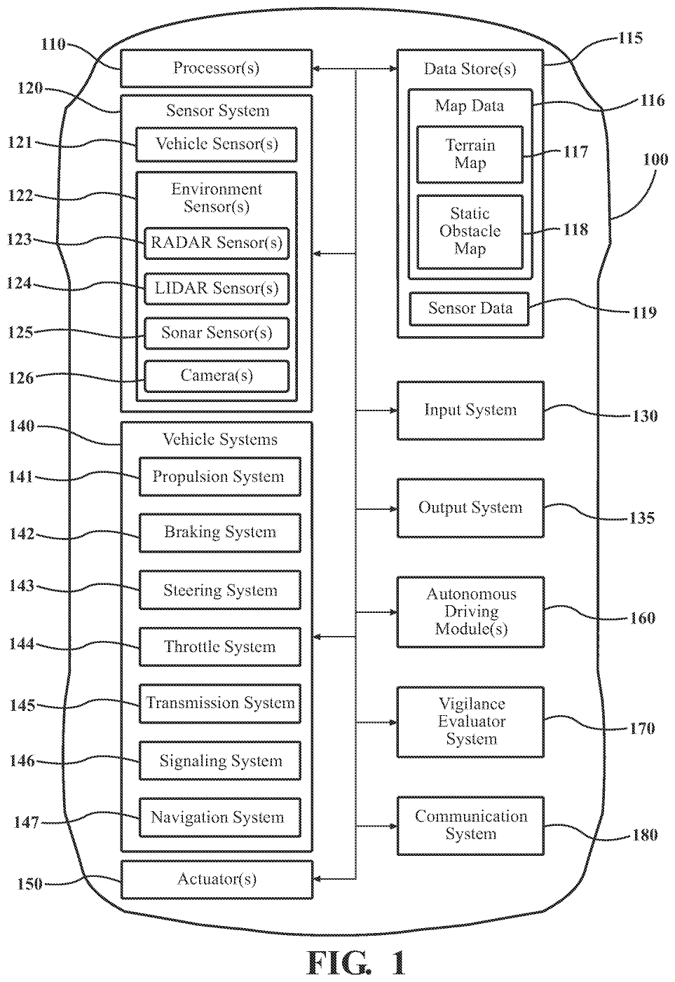

Referring to FIG. 1, an example of a vehicle 100 is illustrated. As used herein, a “vehicle” is any form of motorized transport. In one or more implementations, the vehicle 100 is an automobile. While arrangements will be described herein with respect to automobiles, it will be understood that embodiments are not limited to automobiles. In some implementations, the vehicle 100 may be any robotic device or form of motorized transport that, for example, includes sensors to perceive aspects of the surrounding environment, and thus benefits from the functionality discussed herein associated with analyzing vertical force and estimating operator vigilance. As a further note, this disclosure generally discusses the vehicle 100 as traveling on a roadway with surrounding vehicles, which are intended to be construed in a similar manner as the vehicle 100 itself. That is, the surrounding vehicles can include any vehicle that may be encountered on a roadway by the vehicle 100.

The vehicle 100 also includes various elements. It will be understood that in various embodiments it may not be necessary for the vehicle 100 to have all of the elements shown in FIG. 1. The vehicle 100 can have any combination of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances. For example, as discussed, one or more components of the disclosed system can be implemented within a vehicle while further components of the system are implemented within a cloud-computing environment or other system that is remote from the vehicle 100.

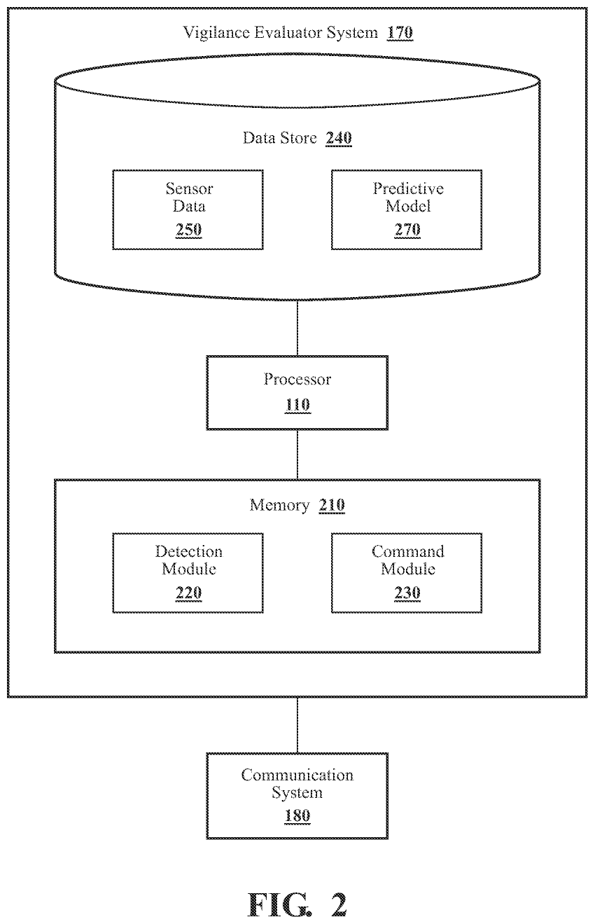

Some of the possible elements of the vehicle 100 are shown in FIG. 1 and will be described along with subsequent figures. However, a description of many of the elements in FIG. 1 will be provided after the discussion of FIGS. 2-7 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, the vehicle 100 includes a vigilance evaluator system 170 that is implemented to perform methods and other functions as disclosed herein relating to estimating operator vigilance. As will be discussed in greater detail subsequently, the vigilance evaluator system 170, in various embodiments, is implemented partially within the vehicle 100, and as a cloud-based service. For example, in one approach, functionality associated with at least one module of the vigilance evaluator system 170 is implemented within the vehicle 100 while further functionality is implemented within a cloud-based computing system.

With reference to FIG. 2, one embodiment of the vigilance evaluator system 170 of FIG. 1 is further illustrated. The vigilance evaluator system 170 is shown as including a processor 110 from the vehicle 100 of FIG. 1. Accordingly, the processor 110 may be a part of the vigilance evaluator system 170, the vigilance evaluator system 170 may include a separate processor from the processor 110 of the vehicle 100, or the vigilance evaluator system 170 may access the processor 110 through a data bus or another communication path. In one embodiment, the vigilance evaluator system 170 includes a memory 210 that stores a detection module 220 and a command module 230. The memory 210 is a random-access memory (RAM), read-only memory (ROM), a hard-disk drive, a flash memory, or other suitable memory for storing the modules 220 and 230. The modules 220 and 230 are, for example, computer-readable instructions that when executed by the processor 110 cause the processor 110 to perform the various functions disclosed herein.

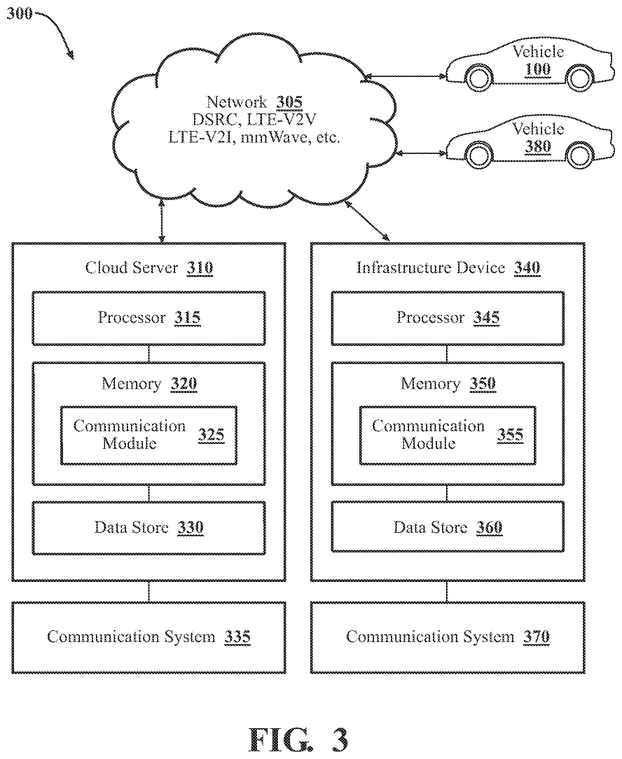

The vigilance evaluator system 170 as illustrated in FIG. 2 is generally an abstracted form of the vigilance evaluator system 170 as may be implemented between the vehicle 100 and a cloud-computing environment. FIG. 3 illustrates one example of a cloud-computing environment 300 that may be implemented along with the vigilance evaluator system 170. As illustrated in FIG. 3, the vigilance evaluator system 170 is embodied at least in part within the cloud-computing environment 300.

With reference to FIG. 3, vehicle 100 may be connected to a network 305, which allows for communication between vehicle 100 and cloud servers (e.g., cloud server 310), infrastructure devices (e.g., infrastructure device 340), other vehicles (e.g., vehicle 380), and any other systems connected to network 305.

The cloud server 310 is shown as including a processor 315 that may be a part of the vigilance evaluator system 170 through network 305 via communication unit 335. In one embodiment, the cloud server 310 includes a memory 320 that stores a communication module 325. The memory 320 is a random-access memory (RAM), read-only memory (ROM), a hard-disk drive, a flash memory, or other suitable memory for storing the module 325. The module 325 is, for example, computer-readable instructions that when executed by the processor 315 cause the processor 315 to perform the various functions disclosed herein. Moreover, in one embodiment, cloud server 310 includes the database 330. The database 330 is, in one embodiment, an electronic data structure stored in the memory 320 or another data store and that is configured with routines that can be executed by the processor 315 for analyzing stored data, providing stored data, organizing stored data, and so on.

The infrastructure device 340 is shown as including a processor 345 that may be a part of the vigilance evaluator system 170 through network 305 via communication unit 370. In one embodiment, the infrastructure device 340 includes a memory 350 that stores a communication module 355. The memory 350 is a random-access memory (RAM), read-only memory (ROM), a hard-disk drive, a flash memory, or other suitable memory for storing the module 355. The module 355 is, for example, computer-readable instructions that when executed by the processor 345 cause the processor 345 to perform the various functions disclosed herein. Moreover, in one embodiment, infrastructure device 340 includes the database 360. The database 360 is, in one embodiment, an electronic data structure stored in the memory 350 or another data store and that is configured with routines that can be executed by the processor 345 for analyzing stored data, providing stored data, organizing stored data, and so on.

Accordingly, in addition to information obtained from sensor data 250, vigilance evaluator system 170 may obtain information from cloud servers (e.g., cloud server 310), infrastructure devices (e.g., infrastructure device 340), other vehicles (e.g., vehicle 380), and any other systems connected to network 305.

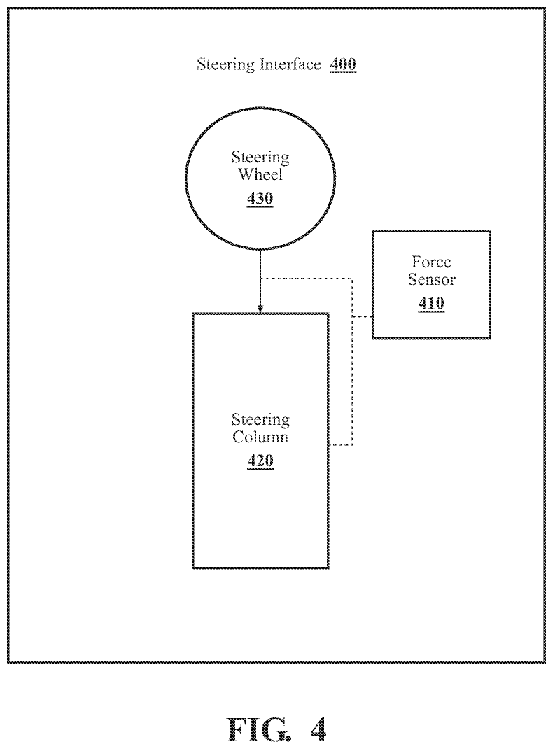

With reference to FIG. 4, one embodiment of a steering interface 400 for use with vigilance evaluator system 170 is shown. Vigilance evaluator system 170 may incorporate steering interface 400 within steering system 143 so as to receive vertical force sensor data from vertical force sensor 410. In various embodiments, steering interface 400 may comprise part of a hydraulic power steering (HPS) system, an electric power hydraulic steering (EPHS) system, a fully electric power steering (EPS) system, or other steering systems known in the art.

Vertical force sensor 410 may be a strain gauge sensor, a load cell sensor, a piezoelectric sensor, or other types of sensors available for measuring force. In some embodiments, vertical force sensor 410 may be coupled to steering column 420 for measuring vertical forces applied to a steering column by a vehicle operator while driving. In some embodiments, vertical force sensor 410 may be coupled between steering column 420 and steering wheel 430 for measuring vertical forces applied between steering column 420 and steering wheel 430 by a vehicle operator while driving. In some embodiments, steering wheel 430 may be a yoke or other steering mechanisms known in the art for delivering steering inputs from the vehicle operator to a steering column.

With respect to measuring vertical force, a vertical force sensor may measure vertical forces applied to a steering wheel or steering column. In some embodiments, vertical force sensor may measure vertical forces applied to a steering wheel or steering column along with longitudinal or lateral forces applied to a steering wheel or steering column. For example, steering column 420 or steering wheel 430 may be placed at an angle in the vehicle relative to the x-y axis of vehicle 100. For example, a tilt-capable form of steering column 420 may allow steering wheel 430 to rotate above or below the cylindrical center of steering column 420 or may allow steering column 420 to rotate. Accordingly, vertical force sensor may primarily measure vertical force on steering column 420 or steering wheel 430 while also receiving secondary measurements of lateral or longitudinal forces on steering column 420 or steering wheel 430 (e.g., due to braking, acceleration, or turning of vehicle 100). In some embodiments, vertical force sensor may measure vertical force through rotational force, such as where vertical force sensor 410 is coupled between steering column 420 and the steering wheel 430.

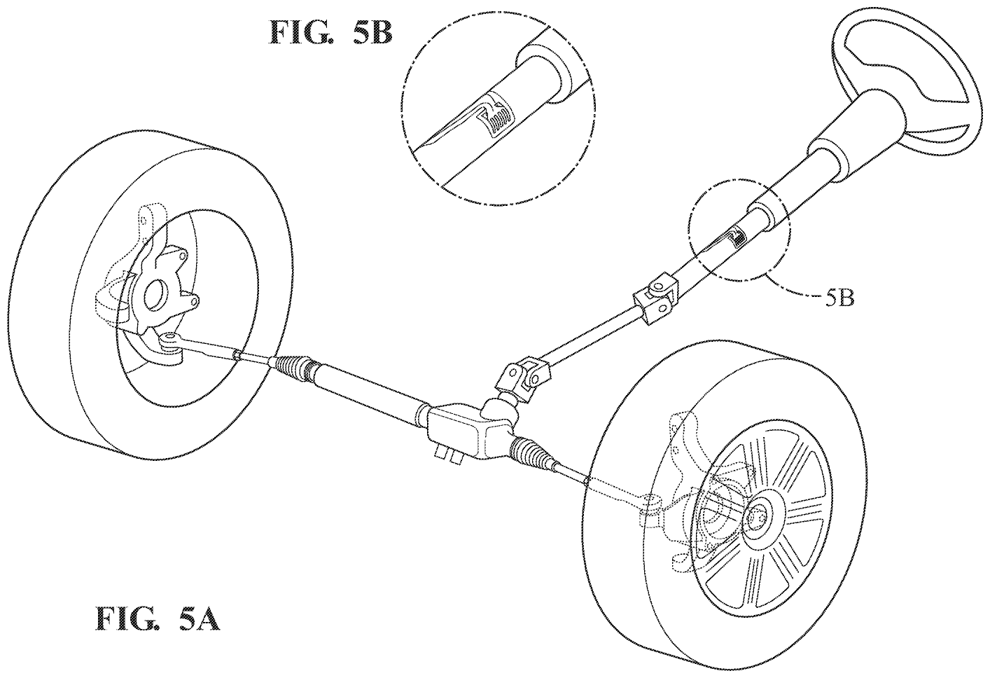

With reference to FIG. 5A, an example of one implementation of steering interface 400 is shown. As shown in FIG. 5B, a strain gauge sensor may be attached to a steering column for measuring vertical forces applied to the steering column by a vehicle operator while driving.

With reference to FIG. 2, the detection module 220 generally includes instructions that function to control the processor 110 to receive data inputs from one or more sensors of the vehicle 100. The inputs are, in one embodiment, observations of one or more objects in an environment proximate to the vehicle 100 and/or other aspects about the surroundings. As provided for herein, the detection module 220, in one embodiment, acquires sensor data 250 that includes at least camera images. In further arrangements, the detection module 220 acquires the sensor data 250 from further sensors such as a radar 123, a LiDAR 124, and other sensors as may be suitable for identifying vehicles and locations of the vehicles. In one embodiment, detection module 220 may also acquire sensor data 250 from one or more sensors that measure vertical forces on a steering interface in the form of vertical force sensor data as described herein.

Accordingly, the detection module 220, in one embodiment, controls the respective sensors to provide the data inputs in the form of the sensor data 250. Additionally, while the detection module 220 is discussed as controlling the various sensors to provide the sensor data 250, in one or more embodiments, the detection module 220 can employ other techniques to acquire the sensor data 250 that are either active or passive. For example, the detection module 220 may passively sniff the sensor data 250 from a stream of electronic information provided by the various sensors to further components within the vehicle 100. Moreover, the detection module 220 can undertake various approaches to fuse data from multiple sensors when providing the sensor data 250 and/or from sensor data acquired over a wireless communication link (e.g., v2v) from one or more of the surrounding vehicles. Thus, the sensor data 250, in one embodiment, represents a combination of perceptions acquired from multiple sensors.

In addition to locations of surrounding vehicles, the sensor data 250 may also include, for example, information about lane markings, and so on. Moreover, the detection module 220, in one embodiment, controls the sensors to acquire the sensor data 250 about an area that encompasses 360 degrees about the vehicle 100 in order to provide a comprehensive assessment of the surrounding environment. Of course, in alternative embodiments, the detection module 220 may acquire the sensor data about a forward direction alone when, for example, the vehicle 100 is not equipped with further sensors to include additional regions about the vehicle and/or the additional regions are not scanned due to other reasons (e.g., unnecessary due to known current conditions).

Moreover, in one embodiment, the vigilance evaluator system 170 includes the database 240. The database 240 is, in one embodiment, an electronic data structure stored in the memory 210 or another data store and that is configured with routines that can be executed by the processor 110 for analyzing stored data, providing stored data, organizing stored data, and so on. Thus, in one embodiment, the database 240 stores data used by the modules 220 and 230 in executing various functions. In one embodiment, the database 240 includes the sensor data 250 along with, for example, metadata that characterize various aspects of the sensor data 250. For example, the metadata can include location coordinates (e.g., longitude and latitude), relative map coordinates or tile identifiers, time/date stamps from when the separate sensor data 250 was generated, and so on. In one embodiment, the database 240 further includes vertical force profiles.

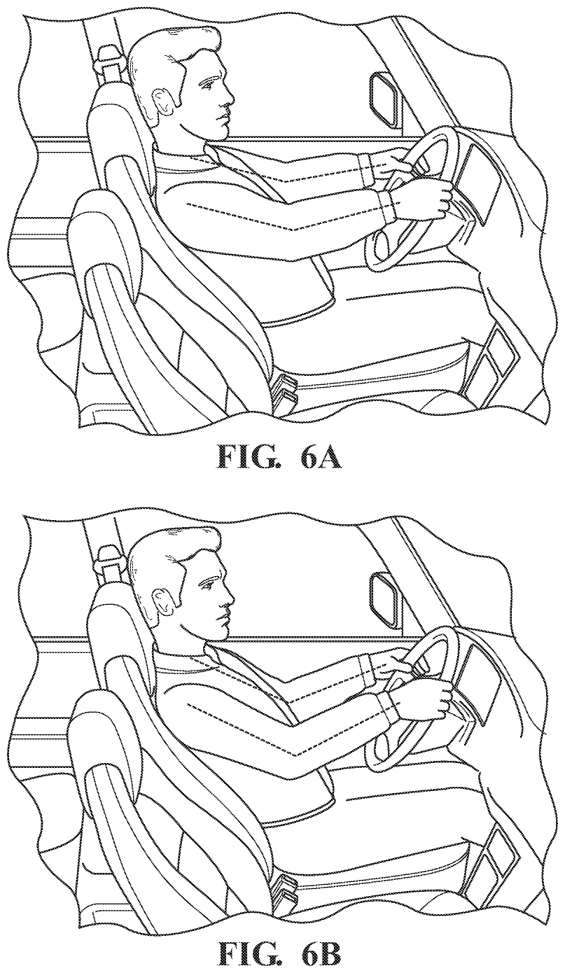

A vertical force profile is a record that has been identified by detection module 220 as representing a value or pattern of vertical force exerted on a steering interface that may be associated with different states of operator vigilance. For example, FIGS. 6A and 6B show, respectively, a first body posture example of a vehicle operator in a high vigilance state and a second body posture example of a vehicle operator in a low vigilance state. In comparing the two, the first body posture example exhibits a greater level of muscle engagement of the arms and shoulders with the steering wheel, such that the elbows are in a raised position, while the second body posture example exhibits a lower level of muscle engagement of the arms and shoulders with the steering wheel, such that the elbows are in a lowered position. Accordingly, in the first body posture example, the greater level of muscle engagement of the arms and shoulders with the steering wheel may result in only a small amount of vertical force being applied to the steering column or the steering wheel. Whereas in comparison, in the second body posture example, the lower level of muscle engagement of the arms and shoulders with the steering wheel, which one may describe as the arms “hanging” off the steering wheel, may result in a substantially greater amount of downward vertical force being applied to the steering column or the steering wheel.

In some embodiments, a set of vertical force profiles may associate different values of vertical force with different levels of operator vigilance, which may then be used as thresholds for determining a level of operator vigilance. For example, a first vertical force profile containing a low value of vertical force may be associated with a high state of operator vigilance, while a second vertical force profile containing a high value of vertical force may be associated with a low state of operator vigilance. In some embodiments, values of vertical force may be normalized, such that they can only be positive or negative, while in other embodiments values of vertical force may be set across positive, zero, or negative values.

In some embodiments, a vertical force profile may describe a pattern or statistical parameters for determining if vertical force sensor data is associated with a specific level of operator vigilance. For example, a vertical force profile may contain a baseline signal or one or more statistical values (e.g., mean, standard deviation) that are associated with a level of operator vigilance. In such vertical force profiles, the baseline signal or statistical parameters may be used in comparison with vertical force sensor data to determine a level of operator vigilance (e.g., by best fit).

In some embodiments, different vertical force profiles may be generated depending on the vehicle operator, time of day, day of the week, weather, traffic, or other conditions that may generally raise or lower expected vertical force sensor data. For example, vehicle operators may exhibit different ranges of vertical force sensor data depending on whether they are driving during the day or at night, in congested traffic versus open road conditions, and so on. Further, such contexts, even if they do not exhibit different ranges of vertical force sensor data, may nonetheless require different vertical force profiles because of other changes in vehicle operator behavior (e.g., following vehicles more closely during the day versus at night).

The detection module 220, in one embodiment, is further configured to perform additional tasks beyond controlling the respective sensors to acquire and provide the sensor data 250. For example, the detection module 220 includes instructions that cause the processor 110 to identify and record vertical force profiles.

In one approach, the detection module 220 uses a machine learning algorithm embedded within the detection module 220, such as a convolutional neural network (CNN), to identify vertical force profiles over the sensor data 250 from which further information is derived. Of course, in further aspects, the detection module 220 may employ different machine learning algorithms or implements different approaches for performing the vertical profile identification. Whichever particular approach the detection module 220 implements, the detection module 220 provides an output of vertical force profiles associated with a vehicle, a vehicle operator, or contexts affecting the vehicle operator (e.g., date, time, weather traffic), which are then stored in sensor data 250.

In some embodiments, detection module 220 may adjust vertical force sensor data in sensor data 250 where it measures longitudinal, lateral, or rotational forces in measuring vertical force. For example, detection module 220 may use information within sensor data 250 to detect braking, acceleration, turning, road bumps, or other events that have an effect on the vertical force data. In one approach, the detection module 220 uses a machine learning algorithm embedded within the detection module 220, such as a convolutional neural network (CNN), to isolate a vertical force measurement based on the sensor data 250 from which further information is derived. Of course, in further aspects, the detection module 220 may employ different machine learning algorithms or implements different approaches for performing the vertical force measurement isolation. Whichever particular approach the detection module 220 implements, the detection module 220 provides an output of vertical force measurements, which are then stored in sensor data 250 as additional vertical force sensor data. In some embodiments, identifying and recording vertical force profiles may occur only after isolating vertical force measurements.

In another approach, the detection module may receive vertical force profiles via communication system 180. For example, a vehicle fleet operator may download a set of vertical forces profiles associated with a vehicle operator to a vehicle that has been assigned for his or her use.

In one embodiment, the command module 230 generally includes instructions that function to control the processor 110 or collection of processors in the cloud-computing environment 300 to aid in the analysis of vertical force sensor data to evaluate operator vigilance.

In some embodiments, based on vertical force sensor data, command module 230 may determine a level of operator vigilance if the vertical force sensor data is within the scope of one or more vertical force profiles. For example, one or more vertical force profiles may set threshold values corresponding to levels of operator vigilance. In such an embodiment, command module 230 may determine a level of operator vigilance based on whether the vertical force sensor data falls between such thresholds (e.g., above a third threshold but below a fourth threshold may be associated with a level 3 state of operator vigilance). In some embodiments, command module 230 may only determine a level of operator vigilance relative to thresholds if the vertical force sensor data satisfies a threshold for a period of time.

In some embodiments, command module 230 may determine a level of operator vigilance if the vertical force sensor data is consistent with a pattern or statistical parameters contained within a vertical force profile. For example, a set of vertical force profiles corresponding to a particular driver, which may be referred to as a driver profile, may have different baselines signals associated with different levels of operator vigilance. In such an embodiment, command module 230 may determine a level of operator vigilance based on how the vertical force sensor data best fits a particular baseline signal (e.g., in the set of vertical force profiles). As another example, command module 230 may determine a level of operator vigilance based on how the vertical force sensor data best fits statistical parameters (e.g., mean, standard deviation) specified in one or more vertical force profiles.

In some embodiments, command module 230 may also evaluate contextual information, such as the date, time, weather, traffic, or other conditions in determining a level of operator vigilance. For example, during the day, command module 230 may only determine a level of operator of vigilance with respect to vertical force profiles specified for daytime operation.

In some embodiments, command module 230 may generate a notification or a takeover request, either of which may be textual, auditory, haptic, visual, or any other form known in the art. For example, command module 230 may issue a notification or takeover request when a level of operator vigilance is determined to be below a threshold. As another example, command module 230 may generate a notification giving an indicator of current or past operator vigilance levels. For instance, a green light may be displayed when the vehicle operator as at a satisfactory level of operator vigilance, while a red light may be displayed when the vehicle operator is at a non-satisfactory level of operator vigilance. In some embodiments, command module 230 may generate a notification or a takeover request because it is unable to determine an estimate of operator vigilance based on an insufficient amount of vertical force sensor data. For example, command module 230 may detect that a vehicle operator does not have his or her hands on the steering wheel (e.g., by a vertical force profile that is set to detect such a situation) and issue a notification or takeover request.

In some embodiments, command module 230 may apply haptic feedback (e.g., via the steering interface) until a sufficient level of operator vigilance is determined via vertical force sensor data. In some embodiments, command module 230 may instruct a vehicle operator to operate the steering interface so as to satisfy a vertical force profile. For example, where operator vigilance is determined to be too low, command module 230 may instruct the vehicle operator to undertake specific actions (e.g., shake the steering interface, raise their elbows).

It should be appreciated that the command module 230 in combination with a prediction model 270 can form a computational model such as a machine learning logic, deep learning logic, a neural network model, or another similar approach. In one embodiment, the prediction model 270 is a statistical model such as a regression model that estimates the level of operator vigilance based on the vertical force sensor data. Accordingly, the model 270 can be a polynomial regression (e.g., least weighted polynomial regression), least squares or another suitable approach.

Moreover, in alternative arrangements, the prediction model 270 is a probabilistic approach such as a hidden Markov model. In either case, the command module 230, when implemented as a neural network model or another model, in one embodiment, electronically accepts the sensor data 250 as an input. Accordingly, the command module 230 in concert with the prediction model 270 produce various determinations/assessments as an electronic output that characterizes the noted aspect as, for example, a single electronic value. Moreover, in further aspects, the vigilance evaluator system 170 can collect the noted data, log responses, and use the data and responses to subsequently further train the model 270.

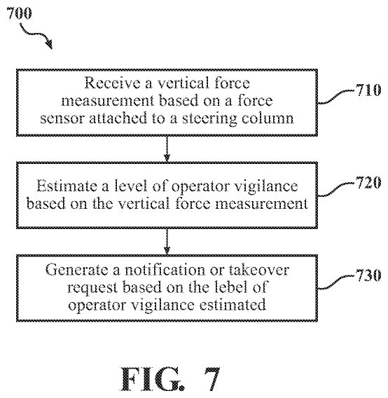

Additional aspects of estimating operator vigilance will be discussed in relation to FIG. 7. FIG. 7 illustrates a flowchart of a method 700 that is associated with estimating operator vigilance. Method 700 will be discussed from the perspective of the vigilance evaluator system 170 of FIGS. 1 and 2. While method 700 is discussed in combination with the vigilance evaluator system 170, it should be appreciated that the method 700 is not limited to being implemented within the vigilance evaluator system 170 but is instead one example of a system that may implement the method 700.

At 710, command module 230 may receive a vertical force measurement based on a force sensor attached to a steering column. In some embodiments, the force sensor may be further attached to a steering wheel. In some embodiments, command module 230 may receive the vertical force measurement as vertical force sensor data within sensor data 250. In some embodiments, command module 230 may receive sensor data 250 and then use predictive model 270 to receive a vertical force measurement, such as remove the influence of vehicle movements.

At 720, command module 230 may estimate operator vigilance based on the vertical force measurement. In some embodiments, command module 230 may may compare the vertical force measurement with a vertical force profile to determine an estimate of operator vigilance. For example, command module 230 may evaluate if the vertical force measurement is appropriately above or below a threshold or within a range specified by a vertical force profile and if so apply the level of operator vigilance associated with the vertical force profile. As another example, command module 230 may compare the vertical force measurement with signals or statistical parameters in a set of vehicle force profiles and apply a level of operator vigilance based on the vehicle force profile that best fits the vertical force measurement.

At 730, command module 230 may generate a notification or takeover request based on the level of operator vigilance estimated. A notification or takeover request may be textual, auditory, haptic, visual, or any other form known in the art. In some embodiments, command module 230 may issue a notification or takeover request when a level of operator vigilance is determined to be below a threshold. In some embodiments, command module 230 may generate a notification giving an indicator of current or past operator vigilance levels. In some embodiments, command module 230 may generate a notification or a takeover request because it is unable to determine an estimate of operator vigilance based on an insufficient amount of vertical force sensor data (or the data being outside of a desired range). In some embodiments, command module 230 may detect that a vehicle operator does not have his or her hands on the steering wheel (e.g., by a vertical force profile that is set to detect such a situation) and issue a notification or takeover request. In some embodiments, command module 230 may apply haptic feedback notification (e.g., via the steering interface) until a sufficient level of operator vigilance is determined via vertical force sensor data.

FIG. 1 will now be discussed in full detail as an example environment within which the system and methods disclosed herein may operate. In some instances, the vehicle 100 is configured to switch selectively between an autonomous mode, one or more semi-autonomous operational modes, and/or a manual mode. Such switching can be implemented in a suitable manner, now known, or later developed. “Manual mode” means that all of or a majority of the navigation and/or maneuvering of the vehicle is performed according to inputs received from a user (e.g., human driver). In one or more arrangements, the vehicle 100 can be a conventional vehicle that is configured to operate in only a manual mode.

In one or more embodiments, the vehicle 100 is an autonomous vehicle. As used herein, “autonomous vehicle” refers to a vehicle that operates in an autonomous mode. “Autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU). The vehicle 100 can include one or more data stores 115 for storing one or more types of data. The data store 115 can include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 115 can be a component of the processor(s) 110, or the data store 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry. The map data 116 can be high quality and/or highly detailed.

In one or more arrangements, the map data 116 can include one or more terrain maps 117. The terrain map(s) 117 can include information about the ground, terrain, roads, surfaces, and/or other features of one or more geographic areas. The terrain map(s) 117 can include elevation data in the one or more geographic areas. The map data 116 can be high quality and/or highly detailed. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

The one or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information on one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100. As noted above, the vehicle 100 can include the sensor system 120. The sensor system 120 can include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such case, the two or more sensors can form a sensor network. The sensor system 120 and/or the one or more sensors can be operatively connected to the processor(s) 110, the data store(s) 115, and/or another element of the vehicle 100 (including any of the elements shown in FIG. 1). The sensor system 120 can acquire data of at least a portion of the external environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect, determine, and/or sense information about the vehicle 100 itself. In one or more arrangements, the vehicle sensor(s) 121 can be configured to detect, and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect, and/or sense one or more characteristics of the vehicle 100. In one or more arrangements, the vehicle sensor(s) 121 can include a speedometer to determine a current speed of the vehicle 100.

Alternatively, or in addition, the sensor system 120 can include one or more environment sensors 122 configured to acquire, and/or sense driving environment data. “Driving environment data” includes data or information about the external environment in which an autonomous vehicle is located or one or more portions thereof. For example, the one or more environment sensors 122 can be configured to detect, quantify and/or sense obstacles in at least a portion of the external environment of the vehicle 100 and/or information/data about such obstacles. Such obstacles may be stationary objects and/or dynamic objects. The one or more environment sensors 122 can be configured to detect, measure, quantify and/or sense other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more radar sensors 123, one or more LIDAR sensors 124, one or more sonar sensors 125, and/or one or more cameras 126. In one or more arrangements, the one or more cameras 126 can be high dynamic range (HDR) cameras or infrared (IR) cameras.

The vehicle 100 can include an input system 130. An “input system” includes any device, component, system, element or arrangement or groups thereof that enable information/data to be entered into a machine. The input system 130 can receive an input from a vehicle passenger (e.g., a driver or a passenger). The vehicle 100 can include an output system 135. An “output system” includes any device, component, or arrangement or groups thereof that enable information/data to be presented to a vehicle passenger (e.g., a person, a vehicle passenger, etc.).

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 141, a braking system 142, a steering system 143, throttle system 144, a transmission system 145, a signaling system 146, and/or a navigation system 147. Each of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system or a geolocation system.

The processor(s) 110, the vigilance evaluator system 170, and/or the automated driving module(s) 160 can be operatively connected to communicate with the various vehicle systems 140 and/or individual components thereof. For example, returning to FIG. 1, the processor(s) 110 and/or the automated driving module(s) 160 can be in communication to send and/or receive information from the various vehicle systems 140 to control the movement, speed, maneuvering, heading, direction, etc. of the vehicle 100. The processor(s) 110, the vigilance evaluator system 170, and/or the automated driving module(s) 160 may control some or all of these vehicle systems 140 and, thus, may be partially or fully autonomous.

The processor(s) 110, the vigilance evaluator system 170, and/or the automated driving module(s) 160 can be operatively connected to communicate with the various vehicle systems 140 and/or individual components thereof. For example, returning to FIG. 1, the processor(s) 110, the vigilance evaluator system 170, and/or the automated driving module(s) 160 can be in communication to send and/or receive information from the various vehicle systems 140 to control the movement, speed, maneuvering, heading, direction, etc. of the vehicle 100. The processor(s) 110, the vigilance evaluator system 170, and/or the automated driving module(s) 160 may control some or all of these vehicle systems 140.

The processor(s) 110, the vigilance evaluator system 170, and/or the automated driving module(s) 160 may be operable to control the navigation and/or maneuvering of the vehicle 100 by controlling one or more of the vehicle systems 140 and/or components thereof. For instance, when operating in an autonomous mode, the processor(s) 110, the vigilance evaluator system 170, and/or the automated driving module(s) 160 can control the direction and/or speed of the vehicle 100. The processor(s) 110, the vigilance evaluator system 170, and/or the automated driving module(s) 160 can cause the vehicle 100 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be any element or combination of elements operable to modify, adjust and/or alter one or more of the vehicle systems 140 or components thereof to responsive to receiving signals or other inputs from the processor(s) 110 and/or the automated driving module(s) 160. Any suitable actuator can be used. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store 115 may contain such instructions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

The vehicle 100 can include one or more autonomous driving modules 160. The automated driving module(s) 160 can be configured to receive data from the sensor system 120 and/or any other type of system capable of capturing information relating to the vehicle 100 and/or the external environment of the vehicle 100. In one or more arrangements, the automated driving module(s) 160 can use such data to generate one or more driving scene models. The automated driving module(s) 160 can determine position and velocity of the vehicle 100. The automated driving module(s) 160 can determine the location of obstacles, obstacles, or other environmental features including traffic signs, trees, shrubs, neighboring vehicles, pedestrians, etc.

The automated driving module(s) 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The automated driving module(s) 160 either independently or in combination with the vigilance evaluator system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the sensor data 250. In general, the automated driving module(s) 160 may function to implement different levels of automation, including advanced driving assistance (ADAS) functions, semi-autonomous functions, and fully autonomous functions. “Driving maneuver” means one or more actions that affect the movement of a vehicle. Examples of driving maneuvers include accelerating, decelerating, braking, turning, moving in a lateral direction of the vehicle 100, changing travel lanes, merging into a travel lane, and/or reversing, just to name a few possibilities. The automated driving module(s) 160 can be configured can be configured to implement determined driving maneuvers. The automated driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The automated driving module(s) 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-7, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A method, comprising:
receiving a vertical force measurement based on a force sensor attached to a steering column; and
estimating a level of operator vigilance based on the vertical force measurement.

2. The method of claim 1, further comprising adjusting the vertical force measurement based on a movement of a vehicle.

3. The method of claim 1, wherein estimating the level of operator vigilance is further based on a driver profile.

4. The method of claim 1, wherein the the force sensor is at least one of a strain gauge sensor, a load cell sensor, or a piezoelectric sensor.

5. The method of claim 1, wherein the force sensor is further attached to a steering wheel.

6. The method of claim 1, wherein estimating the level of operator vigilance is further based on at least one of time, weather, or traffic conditions.

7. The method of claim 1, further comprising generating a notification or takeover request based on the level of operator vigilance estimated.

8. The method of claim 1, wherein receiving the vertical force measurement based on the force sensor further includes wherein the vertical force measurement is obtained from a predictive model applied to vehicle sensor data.

9. A system, comprising:
a processor; and
a memory communicably coupled to the processor and storing machine-readable instructions that, when executed by the processor, cause the processor to:
receive a vertical force measurement based on a force sensor attached to a steering column; and
estimate a level of operator vigilance based on the vertical force measurement.

10. The system of claim 9, wherein the machine-readable instructions further include an instruction that, when executed by the processor, cause the processor to adjust the vertical force measurement based on a movement of a vehicle.

11. The system of claim 9, wherein to estimate the level of operator vigilance is further based on a driver profile.

12. The system of claim 9, wherein the the force sensor is at least one of a strain gauge sensor, a load cell sensor, or a piezoelectric sensor.

13. The system of claim 9, wherein the force sensor is further attached to a steering wheel.

14. The system of claim 9, wherein to estimate the level of operator vigilance is further based on at least one of time, weather, or traffic conditions.

15. The system of claim 9, wherein the machine-readable instructions further include an instruction that, when executed by the processor, cause the processor to generate a notification or takeover request based on the level of operator vigilance estimated.

16. A non-transitory computer-readable medium including instructions that when executed by one or more processors cause the one or more processors to:
receive a vertical force measurement based on a force sensor attached to a steering column; and
estimate a level of operator vigilance based on the vertical force measurement.

17. The non-transitory computer-readable medium of claim 16, wherein the non-transitory computer-readable medium further includes an instruction that, when executed by the one or more processors, causes the one or more processors to adjust the vertical force measurement based on a movement of a vehicle.

18. The non-transitory computer-readable medium of claim 16, wherein to estimate the level of operator vigilance is further based on a driver profile.

19. The non-transitory computer-readable medium of claim 16, wherein the the force sensor is at least one of a strain gauge sensor, a load cell sensor, or a piezoelectric sensor.

20. The non-transitory computer-readable medium of claim 16, wherein the force sensor is further attached to a steering wheel.
